(19) United States
(12) Patent Application Publication
(10) Pub. No.: US 2007/0022220 A1
(43) Pub. Date: Jan. 25, 2007

(54) Bus system having a transmission control module and a transmission interface

(75) Inventors: Po-Yuan Shih, Hsin Chu (TW); Chien-Min Hsieh, Hsin Chu (TW); Yi-Hung Shen, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/347,715

(22) Filed: Feb. 2, 2006

(30) Foreign Application Priority Data
Jul. 21, 2005 (TW) 094124642

(51) Int. Cl. G06F 3/00; G06F 13/28

(52) U.S. Cl. 710/1; 710/22

(57) ABSTRACT

A bus system having a transmission interface and a transmission control module built in a processor is provided. The transmission interface receives instruction signals output from the transmission control module and executes a corresponding data transmission process such that fast data transmission between storage unit of the processor and a host port interface (HPI) of a peripheral device may be fulfilled without an action of the processor, so as to avoid a waste of processor resources and an increase of production cost.

### FIELD OF THE INVENTION

The present invention relates to a bus system, and more particularly to a bus system which is used in a processor such as a central processing unit (CPU) integrated with a host port interface (HPI) memory interface and a direct memory access (DMA) controller.

### BACKGROUND OF THE INVENTION

As the present requirements of high data processing devices increase steadily. The most important component in various data processing devices is a processing unit, for example, a CPU (central processing unit) of a PC (personal computer). The CPU provides functions of the PC to obtain, decode and execute instruction signals, and moreover to transmit and receive data from other sources through a data transmission path such as a bus.

Nowadays, the bus used in a computer is a set of electrical circuits built between many components of the computer for transmitting data. In fact, the bus can be considered as a shared highway by users for it connects different parts of the computer, for example, CPU, memory, input/output port and so on. The bus not only connects different components or devices electrically but also provides function of data transmission, and the bus is managed by a CPU. The data amount which can be transmitted along a bus is decided by the information connection amount of binary bits. Generally, there may be four bus types in a PC as follows: processor bus, memory bus, address bus and I/O bus. Accordingly, how to achieve high data transmission by the bus has been desired for a long time in computer and electron arts.

Referring to FIG. 1, which is a sectional view showing a basic structure of data transmission between a processor 10 of a computer and an HPI of a peripheral device 12 according to a prior art.

As shown in FIG. 1, the processor 10 of the computer comprises an input/output interface 100 and a memory interface 102. The peripheral device 12 comprises an HPI 120 for data transmission between a memory 104 of the processor 10 (The memory 104 can be built in or built out of the processor 10 and is one selected from a group consisting of SRAM, DRAM, DDRAM, DDR II RAM and flash memory), and the HPI 120 of the peripheral device 12 through the memory interface 102 and the input/output interface 100.

During the data transmission of the above structure, the processor 10 sends out an instruction to cause the input/output interface 100 and the memory interface 102 in an enable state so that the data transmission between the memory 104 and the HPI may be fulfilled. That is to say, when the processor 10 sends out an instruction, the input/output interface 100 reads data from the HPI 120 of the peripheral device 12 (or reads data from the memory 104) and stores the data to the memory 104 through the memory interface 102 so as to accomplish the data transmission from the HPI 120 to the memory 104; or the memory interface 102 reads data from the memory 104 and transmits the data to the HPI 120 of the peripheral device 12 through the input/output interface 100 so as to accomplish the data transmission from the memory 104 to the HPI 120. Therefore, the data transmission of the above structure may occupy precious operation timing of the processor 10, waste quite a few processor resources and also reduce the data transmission speed.

Referring to FIG. 2, which is a sectional view showing a basic structure of data transmission between a processor of a computer and an HPI of a peripheral device according to another prior art.

As shown in FIG. 2, the structure includes a processor 20 with a PCI (peripheral component interface) 200 and a memory interface 202; a bridge 21 with a PCI 210 and HPI 212; and a peripheral device 22 with an HPI 220.

During the data transmission of the above structure, the processor 20 sends out an instruction to cause the PCI 200 and the memory interface 202 in an enable state so that the data transmission between the memory 204 of the processor 20 (The memory 204 can be built in or built out of the processor 20 and may be one of SRAM, DRAM, DDR I RAM, DDR II RAM and flash memory.) and the HPI 220 of the peripheral device 22 may be fulfilled through the PCI 200, the memory interface 202 and the bridge 21. However, an instruction of data transmission must be sent out by the processor 20 in this structure, thus precious operation timing of the processor may be occupied and quite a few processor resources may be wasted. Meanwhile, the bridge 21 is needed to connect the PCI 200 of the processor 20 and the HPI 220 of the peripheral device 22 in order to accomplish the data transmission between the memory 204 and the HPI 220, accordingly, design complexity may be increased, data transmission speed may be reduced and production cost may also be increased.

As a result, the present subject to be solved in this art is to provide a bus system for fast data transmission without occupying operation timing of a processor, so that the prior defects of a waste of processor resources caused by occupying the timing of the processor, a low speed of data transmission, design complexity and an increase of production cost can be avoided.

### SUMMARY OF THE INVENTION

In light of the above prior-art drawbacks, a primary objective of the present invention is to provide a bus system which can be used in a processor for data transmission speed between the processor and its peripheral device without occupying operation timing of the processor.

Another objective of the present invention is to provide a bus system for simplifying design and reducing production cost.

In accordance with the above and other objectives, the present invention proposes a bus system which is used in a processor with a storage unit for fast data transmission between storage unit of the processor and a host port interface (HPI) of a peripheral device. The bus system includes at least a transmission control module for outputting instruction signals, and a transmission interface for receiving the instruction signals output from the transmission control module and exchanging data between the storage unit of the processor and the HPI of the peripheral device.

The transmission interface is an HPI and the transmission control module is a direct memory access controller. The bus system composed of the transmission interface and the transmission control module is built in the processor and the transmission interface is controlled by the transmission control module to execute a corresponding data transmission such that direct data transmission between storage unit of the processor and the HPI of the peripheral device may be fulfilled through the transmission interface.

Furthermore, the transmission interface is directly controlled by a control unit of the processor for transmitting data between storage unit and the HPI of the peripheral device.

Accordingly, the bus system of the present invention is to control the transmission interface by the transmission control module for transmitting data between storage unit of the processor and the HPI of the peripheral device without an action of the processor, therefore, not only operation efficiency of the processor and data transmission speed may be largely improved but also design and production cost may be reduced.

### DISCLOSURE OF THE INVENTION

The following special embodiment is provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

Referring to FIG. 3, which is a sectional view showing a basic structure of a bus system 3 used in a processor 4 according to the present invention. The processor 4 is an exemplary processor in this embodiment. The bus system 3 of the present invention provides a more efficient data transmission between an HPI 50 of a peripheral device 5 and a storage unit 40 of the processor 4. The storage unit 40 is built in or built out of the processor 4, and is one selected from a group consisting of static random access memory (SRAM), dynamic random access memory (DRAM), and flash memory with memorizing functionality. The bus system 3 of the present invention operates in any type of Bus Protocol.

As shown in FIG. 3, the bus system 3 comprises a transmission interface 30 and a transmission control module 32. The transmission control module 32 outputs instruction signals to enable the transmission interface 30 to exchange data between the storage unit 40 of the processor 4 and the HPI 50 of the peripheral device 5.

The transmission interface 30 is an HPI used to receive instruction signals output from the transmission control module 32 and execute a corresponding data transmission process according to the instruction signals. In particularly, the transmission interface 30 reads data transmitted from the HPI 50 of the peripheral device 5 according to the received instruction signals and stores the read data to the storage unit 40 of the processor 4. On the other hand, the transmission interface 30 reads data stored in the storage unit 40 according to the received instruction signals and transmits the stored data to the HPI 50 of the peripheral device 5 for further process. A bus arbiter 300 is used to control the data transmission process of the transmission interface 30.

The transmission control module 32 is used to output instruction signals to enable the transmission interface 30, so as to form a data transmission path between the storage unit 40 and the HPI 50 of the peripheral device 5 and accelerate the data transmission process between the storage unit 40 and the HPI 50 of the peripheral device 5. The transmission control module 32 is a direct memory access (DMA) controller used to offer request of bus control right to the bus arbiter 300 before data transmission of the DMA, and after the admission of the bus arbiter 300, the bus control right is turned to the DMA controller for controlling the transmission interface 30 to transmit data fast and directly between the storage unit 40 and the HPI 50 of the peripheral device 5. After the data transmission process is completed, the DMA controller switches the bus control right back to the bus arbiter 300 for a next request of the DMA controller or the processor 4. If the DMA controller and the processor 4 offer a request at the same time, the bus arbiter 300 admits the DMA controller prior to the processor 4 to use the transmission interface 30. Moreover, if the processor 4 offers a request while the DMA controller is using the transmission interface 30, the bus arbiter 300 may still admit the DMA controller prior to the processor 4 to use the transmission interface 30, additionally, if no component (for example, the DMA controller or the processor 4) offers a request after the DMA controller uses the transmission interface 30, the bus arbiter 300 may be in a waiting state and give the right of use till next request of the DMA controller or the processor 4; correspondingly, if the DMA controller offers a request while the processor 4 is using the transmission interface 30, the bus arbiter 300 may still admit the processor 4 prior to the DMA controller to use the transmission interface 30, additionally, if the DMA controller or the processor 4 does not offer a request after the processor 4 uses the transmission interface 30, the bus arbiter 300 may be in a waiting state and give the right of use till next request of the DMA controller or the processor 4. In the present invention, the peripheral device 5 can not only directly write data to the storage unit 40 of the processor 4 (i.e. the memory of the processor) but also read data from the storage unit 40 through the transmission interface 30 controlled by the DMA controller. Accordingly, the processor 4 can do its original operation only after sending a data transmission instruction to the DMA controller in the present invention, and then all data transmission process (that is, writing data of the peripheral device 5 to the storage unit 40, or reading data from the storage unit 40 and transmitting the data to the peripheral device 5) may be accomplished by the DMA controller. Therefore, operation efficiency of the processor and data transmission speed can be largely increased without occupying precious operation timing of the processor, and a waste of processor resources may also be avoided.

Moreover, the transmission interface 30 in the bus system 3 of the present invention is controlled by a control unit (not shown in the figure) of the processor 4 for transmitting data between the storage unit 40 and the HPI 50 of the peripheral device through the transmission interface 30.

Accordingly, the bus system 3 of the present invention includes the transmission interface 30 and the transmission control module 32 built in the processor 4. The transmission interface 30 may receive instruction signals from the transmission control module 32 to transmit data between the storage unit 40 of the processor 4 and the HPI 50 of the peripheral device 5 fast and directly through the transmission interface 30. Thus, data transmission may be fulfilled without an action of the process by the transmission interface 30 which is directly controlled by the transmission control module 32, so that operation timing of the processor 4 can be saved, great waste of processor resources can be avoided, and operation efficiency of the processor 4 can also be increased.

Furthermore, data transmission between the storage unit 40 of the processor 4 and HPI 50 of the peripheral device 5 may be fulfilled by such simple design of the bus system 3 of the present invention, so that the prior defects of design complexity caused by using the bridge and an increase of production cost can be avoided.

The foregoing descriptions of the detailed embodiment are only illustrated to disclose the features and functions of the present invention and not restrictive of the scope of the present invention. It should be understood to those in the art that all modifications and variations according to the spirit and principle in the disclosure of the present invention should fall within the scope of the appended claims.

### BRIEF DESCRIPTION OF THE DRAWINGS

FIG. 1 is a sectional view showing a basic structure of data transmission between a processor and an HPI of a peripheral device according to the prior art;

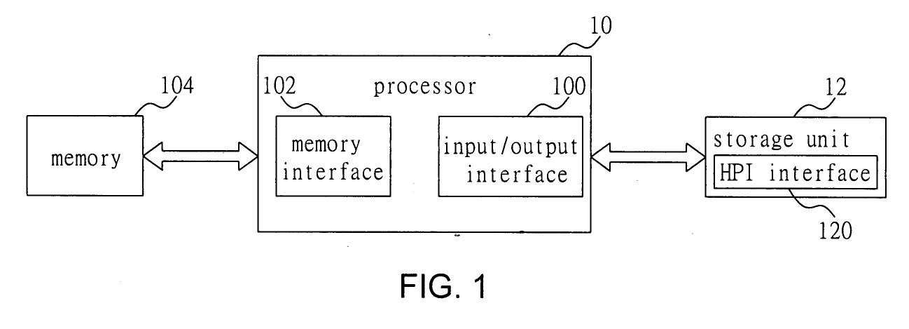

FIG. 2 is a sectional view showing a basic structure of data transmission between a processor and an HPI of a peripheral device according to the prior art; and

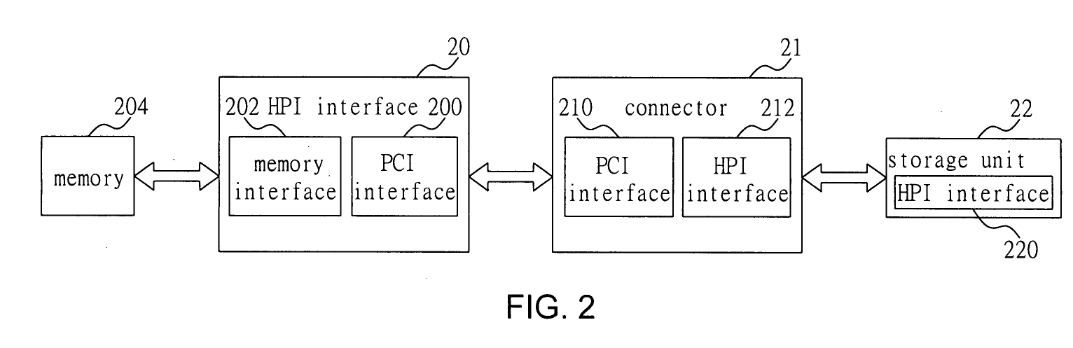

FIG. 3 is a sectional view showing a basic structure of data transmission through a bus system used in a processor according to the present invention.

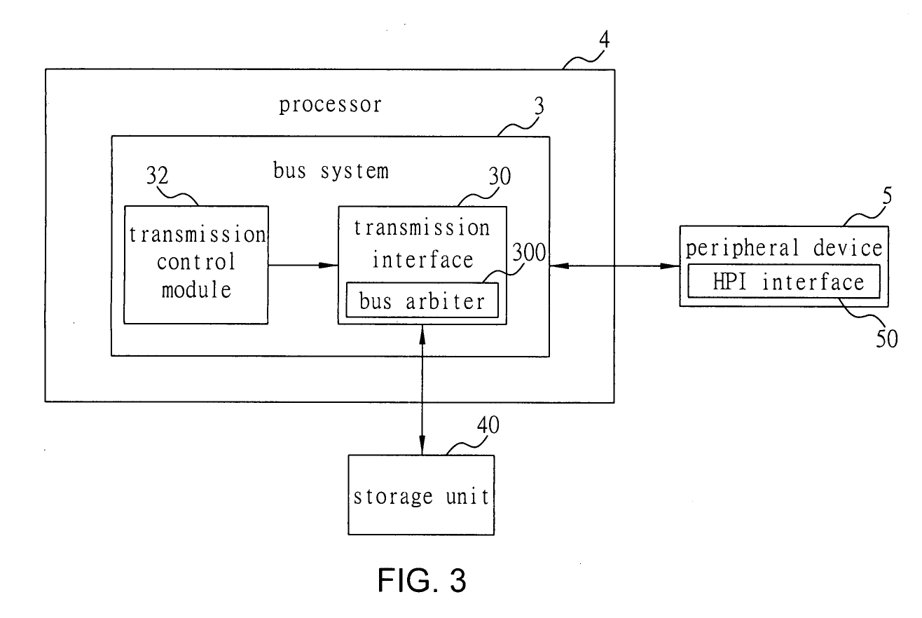

What is claimed is:

1. A bus system applicable to a processor having a storage unit for exchanging data between the storage unit of the processor and a host port interface (HPI) of a peripheral device, the bus system comprising:
at least a transmission control module for outputting instruction signals; and
at least a transmission interface for receiving the instruction signals output by the transmission control module and exchanging data between the storage unit of the processor and the HPI of the peripheral device.

2. The bus system of claim 1, wherein the transmission interface is an HPI.

3. The bus system of claim 1, wherein the transmission control module is a direct memory access (DMA) controller.

4. The bus system of claim 1, wherein the transmission interface is controlled by a control unit of the processor to exchange data between the storage unit of the processor and the HPI of the peripheral device.

5. The bus system of claim 1, wherein the storage unit is a memory device with a memorizing functionality.

6. The bus system of claim 1, wherein the storage unit is one selected from a group consisting of DRAM, SRAM and flash memory.

7. The bus system of claim 1, wherein the bus system operates under a bus protocol.

8. The bus system of claim 1, wherein the storage unit is built in the processor.

9. The bus system of claim 1, wherein the storage unit is built out of the processor.

10. The bus system of claim 1, wherein the transmission interface reads data from the storage unit while receiving the instruction signals output from the transmission control module and transmits the read data to the HPI of the peripheral device.

11. The bus system of claim 1, wherein the transmission interface reads data from the HPI of the peripheral device while receiving the instruction signals output from the transmission control module and transmits the read data to the storage unit.
